(19) United States
(12) Patent Application Publication
(10) Pub. No.: US 2019/0375955 A1
(43) Pub. Date: Dec. 12, 2019

(54) INKJET INK SET WITH AN OVER-PRINT VARNISH COMPOSITION

(71) Applicant: Hewlett-Packard Development Company, L.P., Spring, TX (US)

(72) Inventors: Alireza Rahimi, San Diego, CA (US); George Sarkisian, San Diego, CA (US); Benjamin Abelovski, San Diego, CA (US); Gregg A. Lane, San Diego, CA (US); Tienteh Chen, San Diego, CA (US); Or Brandstein, San Diego, CA (US); Jun Yang, Aguadilla (PR); Olakemi Akinlabi, San Diego, CA (US)

(21) Appl. No.: 16/463,185

(22) PCT Filed: Jun. 30, 2017
(86) PCT No.: PCT/US2017/040390

§ 371 Date: May 22, 2019

(30) Foreign Application Priority Data
Feb. 27, 2017 (US) PCT/US2017/019580
Feb. 27, 2017 (US) PCT/US2017/019582

(51) Int. Cl. C09D 11/40; C09D 11/322; C09D 11/324; C09D 11/38; C09D 11/54; C08L 75/04; C08L 25/06; C08L 33/08; C08K 3/38; C08K 5/098; C08K 5/103; B41M 5/00; B41M 7/00

(52) U.S. Cl. CPC C09D 11/40; C09D 11/322; C09D 11/324; C09D 11/38; C09D 11/54; C08L 75/04; C08K 2003/287; C08L 33/08; C08K 3/38; C08K 5/098; C08K 5/103; B41M 5/0017; B41M 7/0036; C08L 25/06

(57) ABSTRACT

An inkjet ink set comprising a liquid ink and an over-print varnish composition comprising a latex polymer, a boron-containing compound and water. The liquid ink includes a pigment dispersion, a surfactant, a polyurethane binder, a co-solvent and a balance of water. Also disclosed are and inkjet printing system containing such ink set and the method for printing in such inkjet printing system.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for many reasons, including, low printer noise, capability of high-speed recording and multi-color recording. In some instances, an ink set (which may include two or more different colored inks) may be used as an ink source for the inkjet printing system. The ink droplets, that are formed from one or more of the inks that are part of an ink set, are ejected from a nozzle by the inkjet system onto the paper to produce an image thereon. The inks play a fundamental role in the image quality resulting from this printing technique.

### BRIEF DESCRIPTION OF THE DRAWINGS

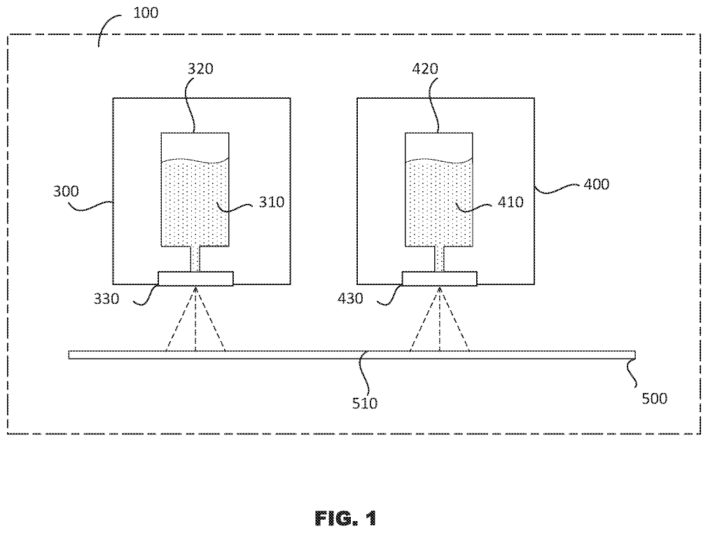

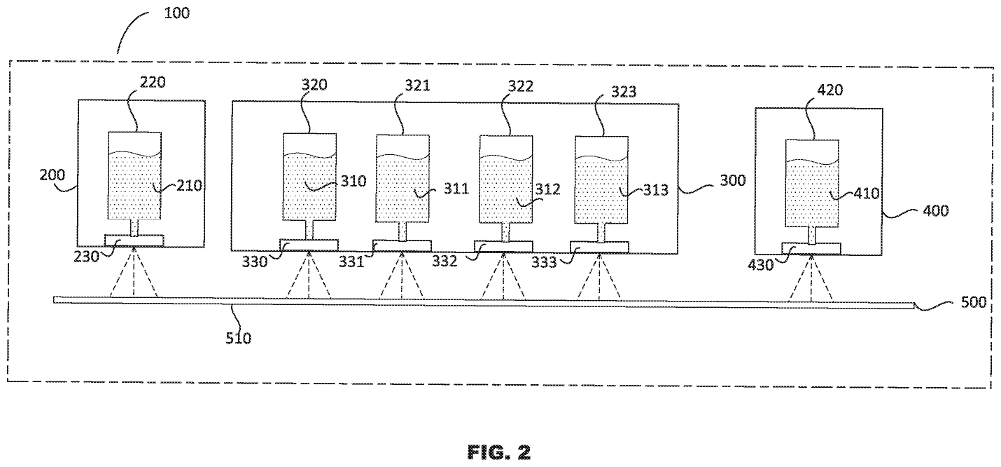

The drawings illustrate various examples of the present print medium and are part of the specification. FIG. 1 is a schematic illustration of an example of an inkjet printing system according to one example of the present disclosure. FIG. 2 is a schematic illustration of another example of an inkjet printing system according to another example of the present disclosure.

### DETAILED DESCRIPTION

Before examples of the present disclosure are disclosed and described, it is to be understood that the present disclosure is not limited to the particular process and materials disclosed herein. It is also to be understood that the terminology used herein is used for describing examples only and is not intended to be limiting, as the scope of protection will be defined by the claims and equivalents thereof. In describing and claiming the present composition and method, the following terminology will be used: the singular forms “a”, “an”, and “the” include plural referents unless the context clearly dictates otherwise. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For examples, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. The percent are by weight (wt %) unless otherwise indicated. As used herein, “image” refers to marks, signs, symbols, figures, indications, and/or appearances deposited upon a material or substrate or printable medium, with either visible or an invisible ink composition.

In inkjet printing, aqueous-based inks are often used on uncoated media, in part because the high surface energy of the aqueous ink enables the ink to spread well on the uncoated media. Aqueous inks may also be desirable for printing on coated offset media. However, coated offset media may be a slow-absorbing medium with high hold-out (i.e., colorants tend to remain on the surface of the media). Additionally, coated offset media may have a relatively low surface energy, and the higher surface energy aqueous inks may not spread well. As a result, images formed from aqueous inks on coated offset media tend to have reduced image quality attributes, such as, for example, gloss or optical density.

For recently-developed industrial printers, such as HP PageWide C500 Press and others, control of bleed and coalescence and avoiding text feathering at high speed can be challenging, especially when printing on coated offset media, which may not be suitable for rapid aqueous ink absorption. As used herein, high speed may refer to print speeds of at least 50 feet per minute (fpm), and up to 1000 fpm.

In various types of inkjet printing, pre-treatment and post-treatment compositions have been applied on the print recording medium before or after the application of an ink composition in view of improving printing characteristics and attributes of the image.

The inkjet ink set, when used in a printing process, has the ability to provide prints with improved print quality, specifically during high-speed printing (e.g., during the printing of at least one hundred pages per minute) and good durability. In addition, the inkjet ink set, when used in a printing process, exhibit improved print reliability (e.g., in terms of nozzle health and kogation). Image quality performance may be measured in terms of the optical density, coalescence, and gloss of a printed image. The term “optical density,” as referred to herein, means the ability of a printed image to retard light rays. A higher optical density equates to better image quality performance. The term “coalescence,” as used to herein, refers to the phenomenon of separately deposited drops of ink. Coalescence can lead to blurring of the printed image and therefore, to poor image quality performance. The term “gloss,” as referred to herein, means the shine or luster of a printed image. A higher gloss is indicative of good image quality performance. Durability performance may be measured in terms of the mechability and abrasion resistance of a printed image. The term “mechability,” as referred to herein, is a form of durability, and means the ability of a printed image to remain undamaged when rubbed immediately after printing.

The ink sets of the present disclosure also have good jettability performances (i.e. good print reliability). The ink sets of the present disclosure have indeed good decap performance. The term “decap performance,” as referred to herein, means the ability of the inkjet ink to readily eject from the printhead, upon prolonged exposure to air, The decap time may be measured as the amount of time that the pen (in a printhead) may be left uncapped (i.e., exposed to air) before the printer nozzles no longer fire properly, potentially because of clogging, plugging, or retraction of solid(s) in the fluid from the drop forming region of the nozzle/firing chamber. In other words, the uncapped time for a thermal inkjet pen may be the length of time that the pen can remain unused and uncapped before spitting (one example of pen servicing) would be required to form an acceptable quality drop. A decreased uncapped time can lead to poor print reliability. In some examples, it is desired for the uncapped time to be from about five minutes to about ten minutes. In other examples, it is desired for the uncapped time to exceed six minutes, especially in the newer, high speed, industrial printers.

The present disclosure relates to inkjet ink sets comprising a liquid ink including a pigment dispersion, a surfactant, a polyurethane binder, a co-solvent and a balance of water; and a varnish composition comprising a latex polymer, a boron-containing compound and water.

The present disclosure also relates to an inkjet printing system comprising an ink dispensing unit, for applying an ink composition on the substrate, comprising at least one ink chambers containing an ink composition comprising a pigment dispersion, a surfactant, a polyurethane binder, a co-solvent and a balance of water; and a varnish dispensing unit, for applying a varnish composition, over the ink composition, said varnish composition comprising a latex polymer, a boron-containing compound and water. The present disclosure also relates to a method for printing in an inkjet printing system, the method comprising applying an ink composition, on a printable medium; the ink composition comprises a pigment dispersion, a surfactant, a polyurethane binder, a co-solvent and a balance of water; drying the ink composition; and applying a varnish composition, on the printable medium, over the ink composition, said varnish composition comprising a latex polymer, a boron-containing compound and water.

The term “ink set” refers to all individual inks or fluids an inkjet printer is equipped to jet. The term “ink set” can refer to a composition package comprising different type of fluids such as a pre-treatment, a post-treatment fluid and/or one or several inks. The ink set can also comprise a post-treatment fluid composition and two or more ink compositions having different colors from each other and that might be used in conjunction, in a common printer system, to form a color image. All fluid compositions present in a common printer can be considered an ink set, or a few inks from a larger group on inks can be considered to be an ink set.

As used herein, the term “inkjet” ink set refers to herein to an ink set that would be used in an inkjet printing system or inkjet printer. Such inkjet printing system or printer can be a thermal inkjet printer, piezoelectric inkjet printers, other drop on demand inkjet printers, and/or continuous inkjet printers.

As used herein, the term “post-treatment fixing” composition designates any fluid composition that can be printed onto a media after the application of an ink composition; such post-treatment composition can also be called “varnish composition” or over-print composition. The over-print varnish composition, or varnish composition, or over-coat composition is a composition that is designed to be applied over a printed image. As overcoat or varnish composition, it is meant herein a composition that will be applied over the printed image and that can form a transparent, protective film. Sais vanish composition can also be considered as a post-printing or over-printing composition. The terms “over-printing” or “post-printing” refer to processes of printing where a first printing solution is printed onto a substrate, and subsequently, a second printing solution is printed onto the first printed solution. The second printing solution would be said to be over-printed with respect to the first printing solution

The inks described herein are liquid thermal inkjet ink that include a colorant dispersed in an ink vehicle. As used herein, the term “ink vehicle” refers to the combination of at least one or more solvents and water to form a vehicle in which the colorant is placed to form an ink. The ink vehicle for these respective inks is formulated so that the vehicle is compatible with polyurethane as a binder (described in further detail below). The term aqueous vehicle can refer to water or a mixture of water and at least one water-soluble, or partially water-soluble (i.e. methyl ethyl ketone) or organic solvent (co-solvent).

The inkjet ink set of the present invention disclosure comprises, at least, a liquid ink and an over-print varnish composition, or varnish composition, or over-coat composition. The over-print varnish composition includes a latex polymer; a boron-containing compound; and a balance of water. The liquid ink, includes a pigment dispersion, a surfactant, a polyurethane binder, a co-solvent and a balance of water.

In some examples, the inkjet ink set of the present invention disclosure comprises an over-print varnish composition and several liquid inks, such inks being one or several inks selected from the group consisting of a black ink with a black pigment dispersion; a yellow ink with a yellow pigment dispersion; a cyan ink with a cyan pigment dispersion and a magenta ink with a magenta pigment dispersion. At least of these inks include a surfactant, a polyurethane binder, a co-solvent and a balance of water. In some other examples, the inkjet ink set further comprises one or several liquid inks selected from the group consisting of orange ink with an orange pigment dispersion; a violet ink with a violet pigment dispersion; and a green ink with a green pigment dispersion. The inkjet ink set of the present invention disclosure can also comprises several liquid inks, such inks being one or several inks selected from the group consisting of a black ink with a black pigment dispersion; a yellow ink with a yellow pigment dispersion; a cyan ink with a cyan pigment dispersion; a magenta ink with a magenta pigment dispersion; an orange ink with an orange pigment dispersion; a violet ink with a violet pigment dispersion and a green ink with a green pigment dispersion and wherein at least one of these inks further includes a surfactant, a polyurethane binder, a co-solvent and a balance of water.

In some examples, the inkjet ink set as defined herein can further comprise a pre-treatment fixing fluid including calcium-containing cationic crashing agents and a balance of water. In some other examples, the pre-treatment fixing fluid comprises a calcium-containing cationic crashing agents that consist of a mixture of calcium propionate and calcium nitrate wherein the calcium propionate is present in an amount ranging from 0 wt % to about 10 wt % and wherein the calcium nitrate is present in an amount ranging from about 15 wt % to 0 wt % based on the total wt % of the pre-treatment fixing fluid.

The Over-Print Varnish Composition

The inkjet ink set of the present disclosure comprises an over-print varnish composition comprising a latex polymer, a boron-containing compound and water; and, at least, a liquid ink. The over-print varnish composition, or varnish composition, or over-coat composition is a composition that is designed to be applied over a printed image. As overcoat or varnish composition, it is meant herein a composition that will be applied over the printed image and that can form a transparent, protective film. Said vanish composition can also be considered as a post-printing composition. Said varnish composition is a jettable varnish composition. As used herein, the term “jettable” is used to refer to a composition that may be jetted, for example from the nozzles of a printhead (such as a thermal or a piezo printhead) that can be provided in an inkjet printing apparatus.

The varnish composition comprises a latex polymer; a boron-containing compound; and water. The varnish composition may further comprise, as optional ingredient, co-solvent and/or surfactants.

In some examples, the varnish composition further comprises a co-solvent. In some other examples, the varnish composition further comprises a surfactant. The varnish composition may also contain buffers, biocides, viscosity modifiers, sequestering agents, stabilizing agents, humectants, and combinations thereof.

In some examples, the varnish composition has a viscosity in the range of about 5 to about 20 cP, where the viscosity is measured at the jetting temperature (i.e. the temperature at which the composition is to be jetted). In some examples, the jetting temperature is a temperature in the range of about 10° C. to about 50° C., for example about 20-40° C., or about 25° C. The viscosity of the varnish composition may be determined according to ISO3219, DIN. The viscosity of the varnish composition can be adjusted by adjusting the amount of water contained in the composition.

In some examples, the varnish composition has a surface tension in the range of about 20-40 dynes/cm, where the surface tension is measured at the jetting temperature (i.e. the temperature at which the composition is to be jetted). In some examples, the jetting temperature is a temperature in the range of about 10° C. to about 50° C., for example about 20-40° C., or about 25° C. The surface tension of the varnish composition may be determined according to ASTM D1331-89.

In some examples, the over-print varnish composition contains water in an amount of from about 40 wt % to about 90 wt % by total weight of the composition, for example or from about 50 wt % to about 85 wt % by total weight of the composition.

In sonic examples, the over-print varnish composition comprises up to about 50 wt % solids by total weight of the composition, for example, up to about 40 wt % solids, or up to about 30 wt % solids by total weight of the composition. In some examples, the varnish composition comprises at least 5 wt % solids by total weight of the varnish composition, for example at least about 10 wt % solids, or at least about 15 wt % solids by total weight of the varnish composition. In some examples, the varnish composition comprises from about 10 wt % to about 30 wt % solids by total weight of the composition. As used herein, the term “solids” of the over-print varnish composition is used to refer to the components of the varnish composition that remain after a varnish image formed by printing a varnish composition is dried, for example following evaporation of water and the co-solvent from the varnish composition.

The over-print varnish composition may be a transparent (e.g. transparent and colorless) varnish composition, for example having no or substantially no colorant (e.g. pigment) and thus may be a pigment-free, or substantially pigment-free composition. The varnish composition may comprise less than 2 wt % solids of colorant, in some examples less than 1 wt % solids of colorant, in some examples less than 0.5 wt % solids of colorant, in some examples less than 0.1 wt % solids of colorant. A “colorant” may be a material that imparts a color to the composition. As used herein, “colorant” includes pigments and dyes, such as those that impart colors such as black, magenta, cyan and yellow to an ink. As used herein, “pigment” generally includes pigment colorants, magnetic particles, aluminas, silicas, and/or other ceramics or organo-metallics. In some examples, the varnish composition when printed as an overcoat varnish layer over a printed image does not substantially affect the color of an underprinted image when viewed with the naked eye.

The varnish compositions described herein may form films around ambient temperature (e.g. around 25° C.) and are therefore useful to protect underprinted images without requiring additional heating to provide a protective film (e.g. a continuous (i.e. uncracked) film) from the varnish composition. In some examples, the varnish composition has a minimum film formation temperature (MFFT) of up to about 40° C., in some examples up to about 30° C. or up to about 25° C. In some examples, the varnish composition has a MFFT in the range of about 10° C. to about 40° C., for example about 10° C. to about 30 ° C., about 1.5° C. to about 30° C., or about 20° C. to about 30° C. In some examples, the varnish composition has a MFFT of about 25° C. The MFFT of a varnish composition may be determined using a MFFT 90 Minimum Film Forming Temperature Instrument (available from Rhopoint® Instruments). The MFFT of a varnish composition may be determined according to ASTM D2354.

The jettable varnish composition comprises a latex polymer; a boron-containing compound; and water. The varnish composition may further comprise, as optional ingredient, co-solvent and/or surfactants.

The boron-containing compound includes boric acid, borax, sodium tetraborate, phenyl boronic acid, butyl boronic acid or combinations thereof. In some examples, the boron-containing compound is selected from the group consisting of boric acid, borax, sodium tetraborate, phenyl boronic acid, butyl boronic acid, and combinations thereof. In some other examples, boron-containing compound is sodium tetraborate.

The boron-containing compound can be present in jettable varnish composition in an amount representing from about 0.1 wt. % to about 20 wt. % based on the total weight of the jettable varnish composition.; or in an amount representing from about 0.5 wt. % to about 10 wt. % based on the total weight of the varnish composition; or in an amount representing from about 1 wt. % to about 5 wt. % based on the total weight of the varnish composition.

The over-print varnish composition comprises a latex polymer. In some examples, the latex polymer is provided to a varnish composition in the form of a latex dispersion which may comprise latex polymer particles dispersed in water.

The latex polymer can have a weight averaged molecular weight Mw greater than about 50 000 or greater than about 100,000 Mw. The latex polymer can have a weight average molecular weight of up to about 2,000,000 Mw. In some examples, the latex polymer has a weight average molecular weight in the range of about 100,000 Mw to about 500,000 Mw.

In some examples, polymeric particulates of the latex polymer have an average particle size of about 500 nm or less, for example about 200 nm or less, or about 100 nm or less. In sonic examples, polymeric particulates of the latex polymer have an average particle size of about 20 nm or greater. In sonic examples, polymeric particulates of the latex polymer have an average particle size in the range of about 20 nm to about 200 nm, for example about 20 nm to about 100 nm. The average particle size (e.g. volume or intensity weighted average particle size) may be determined by dynamic light scattering. In some examples, the latex polymer has an acid number of less than about 150 mg KOH/g, for example less than about 100 mg KOH/g, less than about 80 mg KOH/g, less than about 70 mg KOH/g, or less than about 50 mg KOH/g. The acid number of a polymer, as measured in mg KOH/g can be measured using standard procedures known in the art, for example using the procedure described in ASTM D1386. In some examples, the latex polymer has a glass transition temperature in the range of about 20° C. to about 100° C., for example about 20° C. to about 80° C. The glass transition temperature (Tg) of the latex polymer may be determined using DSC (differential scanning calorimetry), for example determined according to ASTM D3418.

The latex polymer may be any latex polymer which may be provided in an aqueous dispersion. In some examples, the latex polymer comprises an acrylic polymer (e.g. an acrylic copolymer).

The term “acrylic polymer” is used herein to refer to polymers/copolymers derived from acrylic based monomers, for example, acrylic acid monomers, methacrylic acid monomers, acrylate monomers, methacrylate monomers or combinations thereof.

Acrylic latex polymers may be formed from acrylic monomers and thus, may be said to comprise acrylic monomer residues or methacrylic monomer residues. Examples of monomers of the acrylic latex polymer include, by way of illustration and not limitation, acrylic monomers, such as, for example, acrylate esters, acrylamides, and acrylic acids, and methacrylic monomers, such as, for example, methacrylate esters, methacrylamides, and methacrylic acids. The acrylic latex polymer may be a homopolymer or copolymer of an acrylic monomer and another monomer such as, for example, a vinyl aromatic monomer including, but not limited to, styrene, styrene-butadiene, p-chloromethylstyrene, divinyl benzene, vinyl naphthalene and divinyl naphthalene, for example, such that, in some examples in accordance with the principles described herein, the acrylic latex polymer is a predominantly acrylic polymer. By “predominantly acrylic” is meant that the polymer contains greater than about 50%, or greater than about 55%, or greater than about 60%, or greater than about 70%, or greater than about 80%, or greater than about 90%, by weight, of copolymerized units comprising acrylic monomer residues or methacrylic monomer residues, or combinations thereof.

Examples of acrylate monomers include C1 to C30 alkyl acrylates (e.g. C1 to C20 alkyl acrylates, C1 to C10 alkyl acrylates, or C1 to C8 alkyl acrylates). In some examples, acrylate monomers may be selected from the group comprising methyl acrylate, ethyl acrylate, propyl acrylate, isopropyl acrylate, n-butyl acrylate, iso-butyl acrylate, tert-butyl acrylate, 2-ethylhexyl acrylate, lauryl acrylate, isobornyl acrylate, cyclohexyl acrylate, 3,3,5-trimethylcyclohexyl acrylate, isocane acrylate, glycidyl acrylate, 3,4-epoxycyclohexylmethylacrylate, 2-(3,4-epoxycyclohexyl)ethylacrylate, hydroxyethyl acrylate, hydroxypropyl acrylate, hydroxybutyl acrylate, methacrylic anhydride, diethyleneglycol bisacrylate, 4,4′-isopropylidenediphenolbisacrylate (Bisphenol A diacrylate), alkoxylated 4,4′-isopropylidenediphenol bisacrylate, trimethylolpropane trisacrylate and alkoxylated trimethylolpropane trisacrylate.

Examples of methacrylate monomers include C1 to C30 alkyl methacrylates (e.g. C1 to C20 alkyl methacrylates, C1 to C10 alkyl methacrylates, or C1 to C8 alkyl methacrylates), ethylene glycol methacrylates and dimethacrytales. In some examples, methacrylate monomers may be selected from the group comprising methyl methacrylate, ethyl methacrylate, propyl methacrylate, isopropyl methacrylate, n-butyl methacrylate, iso-butyl methacrylate, tert-butyl methacrylate, 2-ethylhexyl methacrylate, lauryl methacrylate, isobornyl methacrylate, cyclohexyl methacrylate, 3,3,5-trimethylcyclohexyl methacrylate, isocane methacrylate, glycidyl methacrylate, 3,4-epoxycyclohexylmethylmethacrylate, 2-(3,4-epoxycyclohexyl)ethylmethacrylate, hydroxyethyl methacrylate, hydroxypropyl methacrylate, hydroxybutyl methacrylate, methacrylic anhydride, diethyleneglycol bismethacrylate, 4,4′-isopropylidenediphenol bismethacrylate (Bisphenol A dimethacrylate), alkoxylated 4,4′-isopropylidenediphenol bismethacrylate, trimethylolpropane trismethacrylate and alkoxylated trimethylolpropane trismethacrylate,

In sonic examples, the latex polymer comprises a (meth)acrylate polymer/copolymer. In some examples, the (meth)acrylate polymer/copolymer may be formed from monomers comprising C1 to C30 alkyl methacrylates (e.g. C1 to C20 alkyl methacrylates, C1 to C10 alkyl methacrylates, or C1 to C8 alkyl methacrylates), C1 to C30 alkyl acrylates (e.g. C1 to C20 alkyl acrylates. C1 to C10 alkyl acrylates, or C1 to C8 alkyl acrylates), ethylene glycol methacrylates, dimethacrytales, methacrylic acids, acrylic acids or combinations thereof.

In some examples, the latex polymer is formed from monomers selected from styrenes, C1 to C30 alkyl methacrylates (e.g. C1 to C20 alkyl methacrylates, C1 to C10 alkyl methacrylates, or C1 to C8 alkyl methacrylates), C1 to C30 alkyl acrylates (e.g. C1 to C20 alkyl acrylates, C1 to C10 alkyl acrylates, or C1 to C8 alkyl acrylates), ethylene glycol methacrylates, dimethacrytales, methacrylic acids, acrylic acids or combinations thereof. In some examples, the latex polymer is a styrene-acrylic polymer. For example, the latex polymer may be formed from a styrene monomer and a monomer selected from acrylic acids, methacrylic acids, acrylates and methacrylates. Examples of commercially available resins that may be used as to provide the latex polymer include Joncryl® 74-A, Joncryl® 77, Joncryl® 80, Joncryl® 89, Joncryl® 537, Joncryl® 538, Joncryl® 585, Joncryl® 624, Joncryl® 660 and Joncryl® 631, available from BASF. Other non-limiting examples of resins or polymers that can be used to provide the latex polymer include acrylic resins available commercially from DSM Company under the names: NeoCryl® A-1105, NeoCryl® A-1110, NeoCryl® A-2082, NeoCryl® A-2099 and NeoCryl® A-2092; acrylic resins commercially available from Alberdingk-Boley® Company under the names: Alberdingk® AC 2310 , AlberdingkUSA® AC 2389, Alberdingk® AS 2065 VP; and acrylic resins commercially available from Dow Company under the names: UCAR Latex DL 420 G, UCAR Latex DL 424 and UCAR Latex DL 432S.

The latex polymer can be present in varnish composition in an amount representing from about 5 wt. % to about 60 wt. % based on the total weight of the varnish composition; or in an amount representing from about 10 wt. % to about 50 wt. % based on the total weight of the varnish composition; or in an amount representing from about 20 wt. % to about 40 wt. % based on the total weight of the varnish composition.

In some examples, the composition can further comprise a co-solvent. The co-solvent and water of the varnish composition may be described as the ‘liquid vehicle’ of the varnish composition. The over-print varnish composition may comprise from about 2 wt % to about 40 wt % of co-solvent by total weight of the composition. The co-solvent may be an organic solvent, for example a water soluble organic solvent. Examples of water soluble organic co-solvents include: aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, co-solvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of polyethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. In some examples, the co-solvent is selected from the group comprising 1,5-pentanediol, 2-pyrrolidone, 2-ethyl-2-hydroxymethyl-1,3-propanediol, diethylene glycol, ethoxylated glycerol, 3-methoxybutanol, 1,3-dimethyl-2-imidazolidinone, or derivatives thereof. Co-solvents may be added to reduce the rate of evaporation of water in the varnish to minimize clogging or to adjust other properties of the ink such as viscosity, pH, and surface tension.

In some examples, the over-print varnish composition can further comprise a surfactant. Examples of suitable surfactants include alkyl polyethylene oxides, alkyl phenyl polyethylene oxides, polyethylene oxide block copolymers, acetylene polyethylene oxides, polyethylene oxide (di)esters, polyethylene oxide amines, protonated polyethylene oxide amines, protonated polyethylene oxide amides, substituted amine oxides, polyethylene oxide alkyl sulfonates, polyethylene oxide alkyl sulfates, polyethylene oxide alkyl phosphates, and the like, as well as fluorocarbon and silicone (e.g. polysiloxane) surfactants. Examples of commercially available materials that may be used to provide the surfactants include Surfynol® 420, Surfynol® 440, Surfynol® 104, Surfynol® 107L, Surfynol® 104PG50, Surfynol® 465, Surfynol® 485, Surfynol® 2502 available from Air Product® (acetylene polyethylene oxide surfactants); BYK® 307, BYK® 333, BYK® 348, BYK® 378, BYK® 3400, BYK® 3410, BYK® 3455 available from BYK Chemie® (polysiloxane surfactants); TEGO® wet 500, TEGO® wet 240, TEGO® twin 4100 available from Evonic® (polysiloxane surfactants); DX4000, DX4005N, DX4010N available from Dynax® fluorochemicals (fluorocarbon surfactants); and Capstone® FS-35, Capstone FS-30, Capstone FS-34, Capstone FS-50 (fluorocarbon surfactants) available from Dupont®. In some examples, the surfactant comprises a silicone surfactant, an acetylene polyethylene oxide surfactant, a fluorocarbon surfactant, or combinations thereof. In some examples, the surfactant comprises a silicone surfactant and an acetylene polyethylene oxide surfactant. The varnish composition may include a surfactant in an amount of about 0.1 wt % to about 5 wt % by total solids of the composition, for example about 0.5 wt % to about 3wt % by total solids of the composition.

The over-print varnish composition may also contain other Additives such as buffering agents, biocides, viscosity modifiers, sequestering agents, stabilizing agents, humectants, and combinations thereof.

The Ink

The inkjet ink set of the present disclosure comprises an over-print varnish composition comprising a latex polymer, a boron-containing compound and water; and, at least, a liquid ink. The ink used are liquid thermal inkjet ink that include a colorant dispersed in an ink vehicle. The term aqueous vehicle can refer to water or a mixture of water and at least one water-soluble, or partially water-soluble (i.e. methyl ethyl ketone) or organic solvent co-solvent). The ink that is part of the ink set includes a pigment dispersion, a surfactant, a polyurethane binder, a co-solvent and a balance of water.

In some examples, the inkjet ink set of the present invention disclosure will comprise a plurality of ink of different color. The ink set will thus include one or several inks selected from the group consisting of a black ink with a black pigment dispersion; a yellow ink with a yellow pigment dispersion; a cyan ink with a cyan pigment dispersion and a magenta ink with a magenta pigment dispersion. The ink set may also include additional ink such as an orange ink with an orange pigment dispersion; a violet ink with a violet pigment dispersion; and/or a green ink with a green pigment dispersion.

Pigments

The ink compositions that are part of the ink set comprise, at least, a pigment. The term pigment refers to any organic or inorganic pigment colorants, magnetic particles, aluminas, silicas, and/or other ceramics, organo-metallics, metallic particulates, or other opaque particles that introduce color to the ink vehicle. Pigments are suspended in the liquid vehicle and are therefore referred as pigment dispersion.

The average particle size of the pigments, present in any of the ink composition of the ink set, may range anywhere from about 50 nm to about 200 nm. In an example, the average particle size ranges from about 80 nm to about 150 nm. The total amount of pigment dispersion in the ink can range from about 1.5% to about 5% based on the total weight of the liquid ink. In some examples, the total amount of pigment dispersion in the ink can range from about 2% to about 4% based on the total weight of the liquid ink.

In some examples, the ink set comprises a black ink with a black pigment dispersion; a yellow ink comprising with yellow pigment dispersion; a cyan ink with a cyan pigment dispersion; and/or a magenta ink with a magenta pigment dispersion. In some other examples, the ink set further comprises an orange ink with an orange pigment dispersion; a violet ink with a violet pigment dispersion and/or a green ink with a green pigment dispersion.

The black ink, that can be part of the ink set of the present disclosure, includes a black pigment. Said black pigment will provide a black color to the black ink. Carbon black may be a suitable black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTER® 35, PRINTEX® U, PRINTEX® V, PRINTEX® 140U, Special Black 5, Special Black 4A, and Special Black 4). An example of an organic black pigment includes aniline black, such as C.I. Pigment Black 1.

The yellow ink, that can be part of the ink set of the present disclosure, includes a yellow pigment. Said yellow pigment will provide a yellow color to the yellow ink. Examples of suitable yellow pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 150, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213. In some examples, the yellow pigment is C.I. Pigment Yellow 74.

The cyan ink, that can be part of the ink set of the present disclosure, includes a cyan pigment. Said cyan pigment will provide a cyan color to the cyan ink. Examples of suitable cyan pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4. C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

The magenta ink, that can be part of the ink set of the present disclosure, includes a magenta pigment. Said magenta pigment will provide a magenta color to the magenta ink. Examples of suitable magenta pigments are organic pigment that include C.I. Pigment Red 1, C.I. Pigment Red 2, I.C. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12. C.I. Pigment Red 14, C.I. Pigment Red 15, C.I. Pigment Red 16, C.I. Pigment Red 17, C.I. Pigment Red 18, C.I. Pigment Red 19, C.L Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57(Ca), C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 213, C.I. Pigment Red 219, C.I. Pigment Red 224, C.I. Pigment Red 245, C.I. Pigment Red 282, C.I. Pigment Red 286, C.I.

The ink set can further include a violet ink. Said violet ink comprises a violet pigment that will impart a violet color to the ink. Examples of suitable violet organic pigments include C.I. pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, C.I. Pigment Violet 50, and C.I. Pigment Violet 55. In some other examples, the ink set can further include a green ink. Said green ink comprises a green pigment that will impart a green color to the ink. Some examples of green organic pigments include C.I. Pigment Green 1, C.I. Pigment Green 2, C.I. Pigment Green 4, C.I. Pigment Green 7, C.I. Pigment Green 8, Pigment Green 10, C.I. Pigment Green 36, and C.I. Pigment Green 45.

In yet some other examples, the ink set can further include an orange ink. Said orange ink comprises an orange pigment that will impart an orange color to the ink. Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, and C.I. Pigment Orange 71.

The pigments that are present in any of the ink composition of the ink set, may be dispersed by an anionic polymer (i.e., anionic polymeric dispersant). The dispersant may be present in an amount ranging from about 0.1 wt % to about 5 wt % of a total wt % of the liquid ink. The above-described pigments can be dispersed into a polymeric dispersion. The polymeric dispersion can assist in dispersing the pigment in a solvent system. In an example, the dispersant may be styrene-acrylic-type dispersants such as acrylic dispersants having i) hydrophilic monomers including acidic monomers, and ii) hydrophobic monomers. The acid number of the dispersant may range from about 120 mg/g to about 300 mg/g. It is to be understood that the styrene-acrylic-type dispersants are water-soluble. As such, no latex polymer is present in the ink composition. Acidic monomers that may be used in the acrylic dispersant may include, for example, acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1 -sulfonic acid, 3-(vinyloxy)propane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, and combinations thereof. Examples of the hydrophobic monomers that can be polymerized in the acrylic dispersant may include styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, ethoxylated nonyl phenol methacrylate, isobornyl methacrylate, cyclohexyl methacrylate, t-butyl methacrylate, n-octyl methacrylate, lauryl methacrylate, tridecyl methacrylate, alkoxylated tetrahydrofurfuryl acrylate, isodecyl acrylate, isobornylmethacrylate, and combinations thereof. Some non-limiting commercial examples of useful styrene acrylic polymers are sold under the trade names Joncryl® (S.C. Johnson Co.), Ucar® (Dow Chemical Co.), Jonrez® (MeadWestvaco Corp.), and Vancryl® (Air Products and Chemicals, Inc.).

Polyurethane Binder

The ink compositions that are part of the ink set comprise a polyurethane binder. The polyurethane binder is present in the ink in the form of a polyurethane dispersion and is therefore referred to as a polyurethane binder. By “polyurethane dispersion” it is meant herein a polyurethane binder or polyurethane that is dispersed in a liquid medium. In some examples, the polyurethane binder is present in a dispersion with water. As used herein, the term “dispersion” refers to a two-phases system where one phase consists of finely divided particles of polyurethane binder distributed throughout a bulk substance, i.e. liquid vehicle. The polyurethane particles being the dispersed or internal phase and the bulk substance being the continuous or external phase (liquid vehicle).

In some examples, the polyurethane dispersion is present in the ink an amount ranging from about 1 wt % to about 20 wt % based upon the total wt % of the inkjet ink. In some other examples, the polyurethane dispersion is present in the ink an amount ranging from about 2 wt % to about 15 wt % based upon the total wt % of the ink composition. In yet some other examples, the polyurethane dispersion is present in the ink an amount ranging from about 3 wt % to about 10 wt % based upon the total wt % of the ink composition. The weight percentages given for the polyurethane dispersion do not account for any other components (e.g., water) that may be present when the polyurethane is park of the dispersion. The polyurethane dispersion may be added with the pigment (e.g., pigment dispersion) and the components of the ink vehicle to form the liquid thermal inkjet ink.

Examples of suitable polyurethanes include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, a vinyl-urethane hybrid polymer, an acrylic-urethane hybrid polymer, a co-polymer thereof, and a combination thereof. The polyurethanes can include polyurethane, polyurea, polyurethane with a curable double bond, polyurethane-graph polyol, or a combination thereof. In some examples, the polyurethanes binder can be a polyurethane having a curable double bond. The polyurethane binder can have a curable double bond that can be (n-(2-hydroxyethyl) acrylamide2-hydroxyehtyl acrylate, 2-hydroxypropyl bis-methyl methacrylate, or a combination thereof. In another example, the polyurethane binder is a polyurethane graph polyol. In a further example, the binder can include a polyurethane graph polyol such as PUG-49, PUG-84, PUG-400 or Pluracol® (available from BASF, New Jersey). In yet another example, the binder can be any of the previously mentioned binders and can further include an acrylic functional group. For example, the binder can include methyl methacrylate, 2-ethylhexyl acrylate, 2-(2-ethoxyethoxy)ethyl acrylate, or a combination thereof.

In some examples, the polyurethanes can have an average molecular weight ranging from 10,000 MW to 100,000 MW. or an average molecular weight ranging from15,000 MW to 50,000 MW.

In some examples, the polyurethane binder contains a polyisocyanate component (A) and a first polyol (B) and a second polyol (C). The polyurethane binder can also be a polyurethane binder dispersion that comprises (A) a polyisocyanate; (B) a first polyol having a chain with two hydroxyl functional groups at one end of the chain and no hydroxyl groups at an opposed end of the chain; (C) a second polyol having a chain with two hydroxyl functional groups at both ends of the chain. The polyurethane binder can further comprise a component (D) which is a carboxylic acid functional group with two hydroxyl functional groups. The polyurethane binder can further comprise a component (E) with a formula [(M⁺)m; (X)n-R—Y] wherein: m is 0 or 1 M is a metal; n is 2 to 10; X is an amino group, R is a C₁ to C₁₈ alkyl group, a C₆ to C₃₀ aromatic compound or a C₄ to C₂₀ aliphatic cyclic compound, and Y is SO₃⁻ or SO₃H with the proviso that when m is 0, Y is SO₃H and when m is 1, Y is SO₃⁻.

In some other examples, the polyurethane binder may he formed from the following components: (a) a polyisocyanate; (b) a polyol having a chain with two hydroxyl functional groups at one end of the chain and no hydroxyl functional groups at the opposed end of the chain; and (c) an alcohol, or a diol, or an amine with a number average molecular weight less than 500; and one of (i) a carboxylic acid; (ii) a sulfonate or sulfonic acid having one amino functional group; (iii) a combination of (i) and (ii); and (iv) a combination of (i) and a homopolymer or copolymer of poly(ethylene glycol) having one or two hydroxyl functional groups or one or two amino functional groups at one end of its chain.

In yet some other examples, the polyurethane binder is a polyurethane binder dispersion wherein polyurethane comprises: (A) a polyisocyanate; (B) a first polyol having a chain with two hydroxyl functional groups at one end of the chain and no hydroxyl groups at an opposed end of the chain; (C) a second polyol having a chain with two hydroxyl functional groups at both ends of the chain; (D) a carboxylic acid functional group with two hydroxyl functional groups; and (F) a compound shown in formula [(M⁺)m; (X)n-R—Y] wherein: m is 0 or 1; M is a metal; n is 2 to 10; X is an amino group, R is a C₁ to C₁₈ alkyl group, a C₆ to C₃₀ aromatic compound or a C₄ to C₂₀ aliphatic cyclic compound, and Y is SO₃⁻ or SO₃H with the proviso that when m is 0, Y is SO₃H and when m is 1, Y is SO₃⁻. In some other examples, polyurethane further comprises an optional homopolymer or copolymer of poly(ethylene glycol) having one or two hydroxyl functional groups or one or two amino functional groups at one end of its chain (F).

In yet some other examples, the polyurethane comprise: (A) a polyisocyanate, which is an isophorone diisocyanate (IPDI); (B) a first polyol having a chain with two hydroxyl functional groups at one end of the chain and no hydroxyl groups at an opposed end of the chain; (C) a polyether polyol having a chain with two hydroxyl functional groups at both ends of the chain; (D) a carboxylic acid functional group with two hydroxyl functional groups; (E) a sulfonate or sulfonic acid functional group having two amino functional groups; and (F) an optional homopolymer or copolymer of poly(ethylene glycol) having one or two hydroxyl functional groups or one or two amino functional groups at one end of its chain.

The polyurethane can also be defined as the following: (A) is isophorone diisocyanate, which is present in the polyurethane in an amount of from about 2.4 wt % to about 30 wt % based on the total weight of the polyurethane, (B) is a copolymer of methyl methacrylate-co-ethylhexylacrylate-co-ethoxyethoxyethylacrylate with two hydroxy groups at one end, which is present in the polyurethane in an amount of from about 40 wt % to about 50 wt % based on the total weight of the polyurethane, wherein (B) the copolymer comprises about 75 wt % of methyl methacrylate, about 15 wt % of ethylhexylacrylate, and about 10 wt % of ethoxyethoxyethylacrylate, each based on the total weight of (B), (C) is polypropylene glycol with a Mₙ, of 1000 g/mol, which is present in the polyurethane in an amount of from about 12 wt % to about 18 wt % based on the total weight of the polyurethane, (D) is dimethylolpropionic acid, which is present in the polyurethane in an amount of from about 2 wt % to about 6 wt % based on the total weight of the polyurethane, and (E) is sodium 2-[(2-aminoethyl)amino]ethanesulphonate, which is present in the polyurethane in an amount of from about 8 wt % to about 12 wt % based on the total weight of the polyurethane.

In some examples, when defining (A) the polyisocyanate, any suitable polyisocyanate may be used. Some suitable polyisocyanates have an average of about two or more isocyanate groups. In an example, the polyisocyanate includes an average of from about 2 to about 4 isocyanate groups per molecule and from about 5 to 20 carbon atoms (in addition to nitrogen, oxygen, and hydrogen). Component (A) may be an aliphatic, cycloaliphatic, araliphatic, or aromatic polyisocyanate, as well as products of their oligomerization, used alone or in mixtures of two or more. For example, a polyisocyanate having an average of two or more isocyanate groups may be used. Some examples of polyisocyanates include hexamethylene-1,6-diisocyanate (HDI), 2,2,4-trimethyl-hexamethylene-diisocyanate (TMDI), 1,12-dodecane diisocyanate, 2,4,4-trimethyl-hexamethylene diisocyanate, 2-methyl-1,5-pentamethylene diisocyanate, isophorone diisocyanate (IPDI), dicyclohexylmethane-4,4-diisocyanate (H12MDI), and combinations thereof. The amount of the polyisocyanate in the polyurethane binder ranges from about 20 wt % to about 45 wt % of the total weight of the polyurethane binder. In an example, polyisocyanate makes up from about 25 wt % to about 35 wt % of the polyurethane binder.

The amount of component (B) (i.e., the first polyol) in the polyurethane-based binder dispersion can range from about 10 wt % to about 70 wt % of the total weight of the polyurethane binder. In an example, component (B) (i.e., the first polyol) can make up from about 30 wt % to about 60 wt % of the polyurethane binder. The first polyol (B) can include any product having a chain with two hydroxyl groups at one end of the chain and no hydroxyl groups at the opposed end of the chain. The first polyol has a number average molecular weight (Mₙ) ranging from about 500 g/mol to about 5000 g/mol. Additionally, the first polyol has a glass transition temperature (T_{g}) ranging from about −2.0° C. to about 100° C. In an example, the glass transition temperature can range from about 0° C. to about 80° C. The first polyol may be formed from the free radical polymerization of a monomer in the presence of a mercaptan that includes two hydroxyl functional groups or two carboxylic functional groups. Some examples of the monomer used to form component (B) include an alkylester of acrylic acid or an alkylester of methacrylic acid, such as methyl (meth)acrylate, ethyl (meth)acrylate, n-butyl (meth)acrylate, tetrahydrofuryl (meth)acrylate, t-butyl (meth)acrylate, 2-ethylhexyl (meth)acrylate, hexyl (meth)acrylate, cyclohexyl (meth)acrylate, phenyl (meth)acrylate, benzyl (meth)acrylate, 2-aziridinylethyl (meth)acrylate, aminomethyl acrylate, aminoethyl acrylate, aminopropyl (meth)acrylate, amino-n-butyl(meth)acrylate, N,N-dimethylaminoethyl(meth)acrylate, N,N-dimethylaminopropyl (meth)acrylate, N,N-diethylaminoethyl (meth)acrylate, and N,N-diethylaminopropyl (meth)acrylate. Some other examples of the monomer used to form component (b) include an acid group containing monomer, such as acrylic acid, methacrylic acid, carboxyethyl (meth)acrylate, 2- meth acryloyl propionic acid, crotonic acid, and itaconic acid. In another example, the monomer used to form component (b) may be an acrylamide, an acrylamide derivative, methacrylamide, or a methacrylamide derivative. Some examples of acrylamide and methacrylamide derivatives include hydroxyethylacrylamide, N,N-methylol(meth)acrylamide, N-butoxymethyl (meth)acrylamide, and N-isobutoxymethyl (meth)acrylamide. Some further examples of the monomer used to form component (b) may be styrene or a styrene derivative. Some examples of styrene derivatives include alpha-methyl styrene, p-aminostyrene, and 2-vinylpyridine. Additionally, the monomer used to form component (B) may be acrylonitrile, vinylidene chloride, a fluorine containing acrylate, a fluorine containing methacrylate, a siloxane containing acrylate, a siloxane containing methacrylate, vinyl acetate, or N-vinylpyrrolidone. Some specific examples include 2,2,2-trifluoroethyl acrylate, 1H,1H,3H-hexafluorobutyl acrylate, 1H,1H,3H-tetrafluoropropyl methacrylate, 1H,1H,5H-octafluoropentyl methacrylate, 1H,1H,5H-octafluoropentyl acrylate, poly(dimethylsiloxane), methacryloxypropyl terminated polydimethylsiloxane DMS-R11 (made by Gelest Chemicals), and (3-acryloxy-2-hydroxypropoxypropyl) terminated polydimethylsiloxane DMS-U21 (made by Gelest Chemicals). It is to be understood that any combination of monomers listed for component (B) may be used.

In some examples, the second polyol (i.e., component (C) can be present in the polyurethane binder in an amount of from about 8 wt % to about 25 wt % based on the total weight of the polyurethane-based binder dispersion. In an example, component (B) (i.e., the first polyol) makes up from about 10 wt % to about 20 wt % of the polyurethane binder. The second polyol(s) can have a number average molecular weight (Mn) of about 500 g/mol to about 3000/mol and have one hydroxyl group attached at each end of the polyol. Examples of second polyols include polyester polyols, polyether polyols, polycarbonate polyol, polyester-polycarbonate polyol, or mixtures thereof. In some examples, the second polyol can be poly(propyleneglycol), poly(tetrahydrofuran), poly(carbonate) polyol, or mixtures thereof. Examples of polycarbonate polyol include polycarbonate polyols from Kuraray Co. Ltd. (e.g., C-590, C-1050, C-1090, C-2050, C-2090, and C-3090) and polycarbonate diols from UBE Industries, Ltd. (e.g., Eternacoll® Uh-50, Eternacoll® Uh-100, Eternacoll® Uh-200, Eternacoll® Ph-5-, Eternacoll® Ph-100, Eternacoll® Ph-200 And Eternacoll® Um90(1/3)).

Component (D) can be a carboxylic acid functional group with two hydroxyl functional groups. The amount of component (D) in the polyurethane-based binder dispersion ranges from 1 wt % to about 10 wt % based upon the total weight of the polyurethane. In an example, component (D) makes up from about 2 wt % to about 6 wt % of the polyurethane binder. In some instances, component (D) includes two or more hydroxyl groups. Component (D) may have a number average molecular weight (Mn) of about 500 g/mol. Examples of component (D) may be derived from hydroxy-carboxylic acids having the general formula (HO)xQ(COOH)y, where Q is a straight or branched hydrocarbon radical containing 1 to 12 carbon atoms, and x is 2 or 3 and y ranges from 1 to 3. Examples of component (D) can include dimethylol propionic acid (DMPA), dimethylol butanoic acid (DMBA), alanine, citric acid, tartaric acid, glycolic acid, lactic acid, malic acid, dihydroxymaleic acid, dihydroxytartaric acid, or mixtures thereof.

In some examples, component (E) can be a compound shown in formula (M⁺) m; n(X)n-R-Y wherein m is 0 or 1; M is a metal; n is 2 to 10; X is an amino group, R is a C₁ to C₁₈ alkyl group, a C₆ to C₃₀ aromatic compound or a C₄ to C₂₀ aliphatic cyclic compound, and Y is SO₃⁻ or SO₃H with the proviso that when m is 0, Y is SO₃H and when m is 1, Y is SO₃⁻. In some examples, m is 1; M is sodium, potassium, magnesium, calcium, or lithium; n is 2 to 4; X is an amino group; R is a C1 to C8 alkyl group; and Y is SO₃⁻. In some other examples, the sulfonate or sulfonic acid amine compound (i.e., component (E)) can have two or more amino functional groups. In some examples, sulfonate or sulfonic acid amine compound (i.e., component (E)) can have two to ten amino functional groups. In some examples, sulfonate or sulfonic acid amine compound (i.e., component (E)) can have two to four amino functional groups. In some examples, sulfonate or sulfonic acid amine compound (i.e., component (E)) can have two amino functional groups. Component (E) may be present in the polyurethane-based binder dispersion an amount ranging from about 1 wt % to about 20 wt % based upon the total weight of the polyurethane-based binder dispersion. In an example, component (E) can be present in an amount ranging from about 2 wt % to about 20 wt % of the polyurethane-based binder dispersion. In another example, component (E) may be present in an amount of about 5 wt % to about 15 wt % of the polyurethane-based binder dispersion.

Some examples of component (E) include ethyldiamineethylsulfonic acid or a salt thereof, ethyldiaminepropylsulfonic acid or a salt thereof, 5-amino-2-(aminomethyl)-1-pentanesulfonic acid or a salt thereof, 2,3-diamino-l-propanesulfonic acid or a salt thereof, 3-[bis(2-aminoethyl) amino]-1-propanesulfonic acid or a salt thereof, 2-[bis(2-aminoethyl)amino]-ethanesulfonic acid or a salt thereof, 2-[(2-aminoethyl) amino]-1-propanesulfonic acid or a salt thereof, 2-[[2-[(1-methylethyl)amino]ethyl]amino]-ethanesulfonic acid or a salt thereof, 2-[(2-aminoethyl)amino]-1-pentanesulfonic acid or a salt thereof, or mixtures thereof. In some other examples, component (E) can also be sodium 2-[(2-aminoethyl) amino]ethanesulphonate or sodium diaminoethylpropylsulfonate.

In some examples, the polyurethane compound further comprises a components (F) which is a Homopolymer or Copolymer of poly(ethylene glycol). The component (F) can be a homopolymer or copolymer of poly(ethylene glycol) having one hydroxyl functional group or one amino functional group. In other examples, component (D) may be a homopolymer or copolymer of poly(ethylene glycol) having two hydroxyl functional groups or two amino functional groups at one end of its chain. The homopolymer or copolymer of poly(ethylene glycol) has a number average molecular weight (Mn) ranging from about 500 g/mol to about 5,000 g/mol. In another example, the homopolymer or copolymer of poly(ethylene glycol) has a number average molecular weight (Mn) ranging from about 500 g/mol to about 3,000 g/mol. Component (F) also has a water solubility of greater than 30% v/v (volume of poly(ethylene glycol) to volume of water). The amount of component (F) in the polyurethane-based binder dispersion ranges from 0 wt % to about 20 wt % based upon the total weight of the polyurethane-based binder dispersion. In an example, component (F) can be present in the polyurethane-based binder dispersion in an amount of from about 5 wt % to about 10 wt % of the polyurethane-based binder dispersion.

Any homopolymer of poly(ethylene glycol) with two hydroxyl or amino groups at one end of the polymer chain may alternatively be used as component (F), as long as the homopolymer has water solubility of > about 30% v/v and a suitable number average molecular weight. As an example, the homopolymer may be two hydroxyl terminated poly(ethylene glycol), where both hydroxyls are located at one end of the chain. One commercially available example is Ymer®N120 (a linear di-functional polyethylene glycol monomethyl ether from Perstorp).

Surfactant

The ink compositions that are part of the ink set comprise include surfactants. In some examples, the surfactants are non-ionic surfactant. In sonic other examples, the surfactants include an acetylenic surfactant and/or a phosphate surfactant.

The surfactant can be present in the ink composition at varying concentrations. In one example, the surfactant can be present in the aqueous ink composition at from about 0.05 wt % to about 4 wt % based on the total wt % of the liquid ink. In another example, the surfactant can be present in the aqueous ink composition from about 0.1 wt % to 3 wt %. In yet another example, the surfactant can be present from about 0.25 wt % to about 1 wt %.

In some examples, the surfactants are acetylenic surfactants. In this example, the acetylenic surfactant may be present in an amount ranging from about 0.25 wt % to about 2 wt % (based on the total wt % of the liquid ink). Acetylenic surfactants can include acetylenic diols, alkoxylated acetylenic diols, and other acetylenic surfactants. Some specific examples include 2,7-dimethyl-4-octyn-3,6-diol, 7-tetradecyn-6,9-diol, 2,4,7,9-tetramethyl-5-decyne-4,7-diol, 1,4-dimethyl-1,4-bi(2-methylpropyl)-2-butyne-1,4-diyl ether, ethylene or propylene oxide condensates thereof, or a combination thereof. Some suitable commercially available acetylenic surfactants include Surfynol® and Dynol® surfactants available from Air Products. Examples of non-ionic surfactant can include Surfynol® SE-F, Dynol® 360, Surfynol® S104, Surfynol® S440, Surfynol® CT -211, or a combination thereof (all available from Air Products & Chemicals Inc., Pennsylvania). In another example, the non-ionic surfactant can include, Surfynol® SE-F, Surfynol® S440, or Surfynol® CT-211. In yet another example, the non-ionic surfactant can include Dynol® 360.

In some examples, the surfactants are phosphate surfactants. In this example, the phosphate surfactant may be present in an amount ranging from about 0.25 wt % to about 2 wt % (based on the total wt % of the liquid ink). In some examples, the phosphate surfactant can be a phosphate ester of fatty alcohols or fatty alcohol alkoxylates. In one example, the surfactant can be a mixture of mono- and diesters, and may have an acid number ranging from 50 to 150. In another example, the phosphate-containing surfactant can be of the Crodafos® family. Specific examples include oleth-3 phosphate, oleth-10 phosphate, oleth-5 phosphate, dioleyl phosphate, ppg-5-ceteth-10 phosphate, C₉-C₁₅ alkyl monophosphate, deceth-4 phosphate, and mixtures thereof. Other specific examples by tradename include Crodafos® N3A, Crodafos® N3E, Crodafos® N10A, Crodafos® HCE, Crodafos® SG, Arlantone® Map 950, Monofax® 831, Monofas® 1214, Monalube® 215, and Atlox® DP13/6.

In some examples, the ink includes a combination of two type of surfactant (a first and a second). The first surfactant can be less water-soluble surfactants (surfactants with a lower HLB value) and the second surfactant can be higher water-soluble surfactants (surfactants with a higher HLB value). Indeed, it has been found that less water-soluble surfactants (surfactants with a lower HLB value) can be used in combination with higher water-soluble surfactants (surfactants with a higher HLB value) to achieve a surface tension of the ink which leads to improved image quality. In the HLB system, which is for use with nonionic surfactants, the lower the HLB value, the more lipophilic (oil-soluble) the surfactant is, while the higher the HLB value, the more hydrophilic (water-soluble) the surfactant is. The HLB value in the HLB system may range from 0 to 20 or more. In a somewhat more detailed view of the HLB value, a surfactant having a value of 0 to 6 is considered to be hydrophobic (oil-soluble), while a surfactant having a value between 6 and 12 is considered to be water-dispersible, and a surfactant having a value greater than 12 is considered to be hydrophilic (water-soluble).

In some examples, the ink includes a combination of two type of surfactant (a first and a second). The first surfactant can be less water-soluble surfactants (surfactants with a lower HLB value) and the second surfactant can be higher water-soluble surfactants (surfactants with a higher HLB value). The HLB value of the first surfactant may be greater than about 6 and less than about 12, while the HLB value of the second surfactant may be less than about 6. In the mixture of the two surfactants described above, the first HLB value may be less than about 6, while the second HLB value may also be less than about 6.

In one example, the first surfactant (having the HLB value greater than 6 and less than 12) may be present in an amount ranging from about 0.05 weight percent (wt %) to about 2 wt % based on the total wt % of the inkjet ink. The second surfactant (having the HLB value less than 6) may also be present in an amount ranging from about 0.05 wt % to about 2 wt % based on the total wt % of the inkjet ink. The total concentration of the two surfactants in the inkjet ink may be within a range of about 0.1 wt % to about 4 wt %. In another example, the first surfactant (having the HLB value less than 6) may be present in an amount ranging from about 0.05 weight percent (wt %) to about 0.9 wt % based on the total wt % of the inkjet ink. The second surfactant (also having the HLB value less than 6) may also be present in an amount ranging from about 0.05 wt % to about 0.9 wt % based on the total wt % of the inkjet ink. In this case, the maximum concentration of the two surfactants in the inkjet ink may he less than about 0.9 wt %, so as avoid any solubility issues of using two surfactants that each has low water solubility.

Co-Solvent

The ink compositions that are part of the ink set comprises a co-solvent. In some examples, the co-solvent is a glycol ether co-solvent. Examples of the glycol ether co-solvent include glycol alkyl ethers, propylene glycol alkyl ethers, and higher homologs (C₆-C₁₂) of polyethylene glycol alkyl ethers. Glycol ether co-solvents can have the molecular formula of R′—O—CH₂CH₂OH, where R′ is a C₁-C₇ liner, branched, or cyclic alkyl group. In some examples, a single glycol ether co-solvent can be used. In other examples, a combination of glycol ether co-solvents can be used.

In some examples, the glycol ether can include ethylene glycol monobutyl ether. In some other examples, the glycol ether can include tripropylene-glycol methyl ether, dipropylene glycol butyl ether, diethylene glycol ethyl ether, propylene glycol phenyl ether, or a combination thereof. In yet some other examples, the non-volatile glycol ether co-solvent is tripropylene-glycol methyl ether. The glycol ether co-solvent can be a non-volatile glycol ether co-solvent. The non-volatile glycol ether co-solvent can be dipropylene glycol butyl ether, diethylene glycol ethyl ether, or a combination thereof. In a further example, the non-volatile glycol ether co-solvent can be propylene glycol ether. In some examples, the boiling point of the non-volatile glycol ether co-solvent can be 220° C. as mentioned, or can be 240° C. or greater. Examples of non-volatile glycol ether co-solvents having a boiling point over 240° C. can include tripropylene glycol methyl ether, dipropylene glycol butyl ether, or tripropylene glycol propyl ether. In one example, the non-volatile glycol ether co-solvent can be a non-hazardous substance as determined by the EPA at the time of filing the present disclosure. In some examples, the non-volatile glycol ether co-solvent can be hydrophobic and/or include hydrophobic functional groups.

The non-volatile glycol ether co-solvent can be present in the aqueous ink composition at varying concentrations. In one example, the non-volatile glycol ether co-solvent can be present at from about 0.3 wt % to about 4.5 wt %. In another example, the non-volatile glycol ether co-solvent can be present from about 1 wt % to about 3 wt %. In yet another example, the non-volatile glycol ether co-solvent can be present at from about 2 wt % to about 3 wt %.

Humectant Solvent

The ink compositions that are part of the ink set can comprise a humectant solvent. In some examples, the ink composition comprises a humectant solvent including a hydrophilic group. The humectant solvent can include glycerol, Dantocol® DHE (Di-(2-hydroxyethyl)-5,5 dimethylhydantoin) (available from Lonza® Inc., New Jersey), tetraethylene glycol, tripropylene glycol, 2-hydroxyethyl pyrrolidone (2HE2P), (2HE2P), Liponic® EG-1 or LEG-1, or combinations thereof. In one example, the humectant solvent includes glycerol (Glycereth-6). In yet another example, the humectant solvent includes 2-hydroxyletheyl-2-pyrrolidone. In a further example, the humectant solvent includes tripropylene glycol. In yet a further example, the humectant solvent includes glycerol, 2-hydroxyletheyl-2-pyrrolidone, LEG-1, or a combination thereof. The humectant solvent can be present in the ink composition in an amount representing from about 1 wt % to about 15 wt % of the ink composition. In another example, the humectant solvent can be present from about 2 wt % to about 10 wt %. In yet another example, the humectant solvent can be present from about 3 wt % to about 8 wt % by total weight of the ink composition.

Wax Emulsion

The ink compositions that are part of the ink set may comprise a wax. In some examples, the wax is a wax emulsion. In some other examples, the ink compositions that are part of the ink set comprises a polyethylene (PE) wax emulsion. The PE wax emulsion includes a polyethylene (PE) wax. In some other examples, the wax emulsion and the inks exclude all other waxes besides the PE wax. Without being linked by any theory, it is believed that the ink, including the wax emulsion may have reduced agglomerate formation (as compared to other comparable inks including other waxes, e.g., polyethylene waxes) in thermal inkjet printhead nozzles both during storage and printing. In some examples, the wax emulsion has a particle diameter that is less than 50 nm. In some other examples, the wax emulsion and the liquid ink are free from wax particles with a particle diameter equal to or greater than 50 nm. An example of a suitable wax is a wax emulsion such as Liquilube® 405, available from Lubrizol (Wickliffe, Ohio). In some examples, the wax can be present in an amount ranging from about 0.2 wt % to about 2.5 wt %. In some other examples, the wax can be present in an amount ranging from about 0.3 wt % to about 2 wt %. In some other examples, the wax can be present in an amount ranging from about 0.5 wt % to about 1 wt %. The wax emulsion may be present in the liquid ink in an amount ranging from about 0.1 wt % to about 1.5 wt % (based on the total wt % of the ink).

Water and Other Ingredients

The inkjet ink compositions described herein also include water (e.g., deionized water) in amounts to make up the balance of the inkjet ink compositions. In some examples, water can be present in the inkjet compositions in amounts greater than about 50 wt % based on the total weight of the inkjet ink composition. In some examples, the water can be present in the inkjet ink compositions in amounts from about 50 wt % to about 90 wt % based on the total weight of the inkjet ink composition. In other examples, the inkjet ink composition can include from about 60 wt % to about 88 wt % water. In further examples, the inkjet ink composition can include from about 70 wt % to about 85 wt % water.

The ink compositions that are part of the ink set might also comprise optional ingredients that are part of the ink vehicle. Such optional ingredient could be for examples, antimicrobial agents or anti-kogation agent. In some examples, the ink vehicle of the liquid thermal inkjet ink may also include viscosity modifier, materials for pH adjustment, sequestering agent, preservative, jettability additive, and the like.

The liquid vehicle may also include antimicrobial agent. Suitable antimicrobial agents include biocides and fungicides. Example antimicrobial agents may include the Nuosept® (Ashland Inc.), Ucarcide® or Kordek® (Dow Chemical Co.), and Proxel® (Arch Chemicals) series, and combinations thereof. In an example, the liquid ink may include a total amount of antimicrobial agents that ranges from about 0.1 wt % to about 0.25 wt %. In some instances, the antimicrobial agent may be present in the pigment dispersion that is added to the other ink components.

An anti-kogation agent may also be included in the ink vehicle. Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as Crodafos® O3A or Crodafos® N-3 acid) or dextran 500k. Other suitable examples of the anti-kogation agents include Crodafos® HCE (phosphate-ester from Croda Int.), Crodafos® N10 (oleth-10-phosphate from Croda Int.), or Dispersogen® LFH (polymeric dispersing agent with aromatic anchoring groups, acid form, anionic, from Clariant), etc. The anti-kogation agent may be present in the liquid ink in an amount ranging from about 0.1 wt % to about 1 wt % of the total wt % of the liquid ink.

Inkjet Printing System

The present invention disclosure relates to an inkjet printing system and a method of printing in an inkjet printing system. In some examples, the inkjet printing system is a two-stage inkjet printing system including an ink dispensing unit for dispensing an ink composition on the substrate during printing and a varnish dispensing unit, for applying an over-print varnish composition, over the ink composition, on the printed substrate. Further, the inkjet printing system can include a drying unit for drying the print on the substrate once the fixer composition and the ink composition are applied thereon.

In some examples, the inkjet printing system comprises an ink dispensing unit, for applying an ink composition on the substrate, comprising at least one ink chambers containing an ink composition comprising a pigment dispersion, a surfactant, a polyurethane binder, a co-solvent and a balance of water; a varnish dispensing unit, for applying an over-print varnish composition, over the ink composition, said over-print varnish composition comprising a latex polymer, a boron-containing compound and water.

In some other examples, the ink dispensing unit comprises several ink chambers with inks of different colors, said inks being one or more inks selected from the group consisting of a black ink with a black pigment dispersion; a yellow ink with a yellow pigment dispersion; a cyan ink with a cyan pigment dispersion; a magenta ink with a magenta pigment dispersion; an orange ink with an orange pigment dispersion; a violet ink with a violet pigment dispersion and a green ink with a green pigment dispersion.

The varnish dispensing unit can include a varnish reservoir to store the varnish composition and a varnish nozzle to eject the varnish composition on the printed medium (i.e. the substrate with the ink composition) after the ink jetting step. In said example, the ink dispensing unit can have a structure similar to the varnish dispensing unit, and can include an ink reservoir to store the ink composition and an ink nozzle to eject the ink composition on the substrate for printing. In one case, the varnish dispensing unit can be provided downstream of the ink dispensing unit. The varnish composition is applied on the substrate (or printable medium) after the application of the ink composition.

During operation of the inkjet printing system, the ink dispensing unit applies the ink composition on the printable medium and. In some examples, the ink is dried before the application of the over-print varnish composition. The over-print varnish composition can be applied offline of the printing process or can be applied in line during web printing process.

The varnish dispensing unit dispenses the over-print varnish composition on the printed medium that has be printed with ink and dried. Once the over-print varnish composition. The printable medium can subsequently dried.

The combination of the ink and varnish compositions can be used for high speed printing in the inkjet printing systems for a variety of substrates or printable medium, including slow-absorbing printing media, such as coated offset media or other semi-porous media. For example, the inkjet printing system can have a printing speed of about 1000 feet per minute (fpm), and can provide a durable and smear-resistant print which has a glossy texture and water fast colors. In one case, the inkjet printing system can achieve printing speeds in the range of about 100 fpm to 1000 fpm with the ink composition and the fixer composition used in the manner described above, without compromising on the quality or durability of the print.

In some other examples, the inkjet ink set as defined herein can further comprise a pre-treatment fixing fluid including calcium-containing cationic crashing agents and a balance of water. The inkjet printing system as defined herein can thus further comprises a fixer dispensing unit that would include a fixer reservoir to store a pre-treatment fixing fluid and a fixer nozzle to eject the pre-treatment fixing fluid on the printed medium (i.e. the substrate with the ink composition) before the application of the ink composition.

FIG. 1 illustrates a schematic of an inkjet printing system 100, according to an example of the present disclosures. In an example, the inkjet printing system 100 can be a two-stage printing system having an ink dispensing unit 20 and a varnish dispensing unit 30, and can be used for printing on a substrate (or printable medium) 500. The ink dispensing unit 20 and the varnish dispensing unit 30 can dispense the ink composition and the varnish composition, respectively, as disclosed in the present subject matter, for achieving high speed printing with durable quality of prints.

In some examples, the system for printing an ink-set, or inkjet printing system, 100 includes an ink dispensing unit 300 and a varnish dispensing unit 400 wherein the ink dispensing unit 300 comprises an ink composition 310 that is contained in a chamber (or reservoir) 320 which is fluidically coupled to an inkjet fluid ejector (or nozzle) 330. The varnish dispensing unit 400 comprises an over-print varnish composition 410 that is contained in a chamber (or reservoir) 420 which is fluidically coupled to an inkjet fluid ejector (or nozzle) 430. The ink dispensing unit 300 can include an ink reservoir or chamber 320 for storing the ink composition and an ink nozzle 330 for ejecting the ink composition 310 on the upper surface 510 of a substrate 500 during printing. Similarly, the varnish dispensing unit 400 can include a varnish reservoir 420 for storing the varnish composition 410 and a varnish nozzle 430 for ejecting the over-print varnish composition on the substrate or printable medium 500. In some examples, each of the dispensing units is configured to eject its respective ink or varnish compositions onto a surface 510 of a print media 500 during the printing process. In sonic examples, the chambers 320 and 420 are ink or varnish reservoirs that are in fluid communication with fluid ejectors 330 and 430 that are inkjet printhead. Said fluid communication can be done thought a fluid conduit. In some other examples, the chambers 320 and 420 are ink or varnish reservoirs and are part of inkjet cartridges, the ink or varnish reservoirs are in direct fluid communication with the inkjet printhead.

FIG. 2 illustrates a schematic of an inkjet printing system 100, according to another example of the present disclosures. The system for printing an ink-set, or inkjet printing system, 100 include a fixer dispensing unit 200, an ink dispensing unit 300 that comprises a plurality of ink fluid ejectors, each of which are fluidically coupled to at least one other chamber and a varnish dispensing unit 400. The fixer dispensing unit 200 comprises a pre-treatment fixing fluid composition or fixer composition 210 that is contained in a chamber (or reservoir) 220 which is fluidically coupled to a fluid ejector (or nozzle) 230. The varnish dispensing unit 400 comprises an over-print varnish composition 410 that is contained in a chamber (or reservoir) 420 which is fluidically coupled to a fluid ejector (or nozzle) 430. In some example, the ink dispensing unit 300 comprises several inks chambers 320, 321, 322 and 323 containing different inks of different colors (i.e. containing different pigment dispersions). The inkjet printing system can have an ink dispensing unit that comprises several ink chambers with inks of different colors. The ink dispensing unit 300 can comprise a first ink chamber 320 including a black ink 310; a second ink chamber 321 including a yellow ink 311; a third ink chamber 322 including a cyan ink 312 and a fourth ink chamber 323 including a magenta ink 323, for example. It is to be understood that any suitable or desired number of fluid ejectors and chambers may be used in the inkjet printing system 100 described herein. Further, it is to be understood that the ink chambers may be in fluid communication with a single fluid ejector, or may be in fluid communication with their own respective fluid ejector.

In one case, the inkjet printing system 100 can be thermal inkjet printing system which involves use of heat for achieving ejection of the ink composition and the ink composition from the ink dispensing unit 300 and the varnish dispensing unit 400, respectively. In another case, the inkjet printing system 100 can be a charge controlled printing system in which electrostatic attraction is used for ejecting the ink composition from the ink dispensing unit 300 and the varnish composition from the varnish dispensing unit 400. In yet another case, the inkjet printing system 100 can use vibration pressure generated by a piezoelectric element for ejecting the ink composition and the varnish composition, and the fixer composition when present. In still another example, the inkjet printing system 100 can use an acoustic technique for ejection of the compositions. In this case, an electric signal is transformed into an acoustic beam and the compositions are irradiated by the acoustic beam so as to be ejected by radiation pressure. The inkjet printing system 100 can use a combination of the above-mentioned techniques for ejection of the ink and varnish compositions and eventually fixer composition when present). For example, the ink dispensing unit 300 can use one of the above-mentioned techniques for dispensing the ink and the varnish dispensing unit 400 can use another above-mentioned technique for dispensing the ink.

In some examples, the inkjet printing system 100 can include a substrate guiding unit for handling the substrate web during printing and a drying unit for drying the ink and varnish compositions applied on the substrate web. In one case, the substrate guiding unit can include a web mounting spool on which a substrate web is mounted. In addition, the substrate guiding unit can include a puller assembly and a plurality of web guides. The puller assembly can continuously pull the substrate web from the web mounting spool, during printing operation of the inkjet printing system 100. In one case, the puller assembly can include a pair of contact rollers having an anti-friction coating, say rubber coating, thereon. The substrate web can pass through the pair of contact rollers and be pulled by the rotational motion of the rollers. Further, the puller assembly can be provided downstream with respect to the ink dispensing unit 300 and the varnish dispensing unit 400. The plurality of web guides can support the substrate web and maintain adequate tension in the substrate web, during the movement of the substrate web for printing. In an example, the plurality of guides can include adjustable rollers for adjusting the tension in the substrate web for effective operation.

In one example, the drying unit can be an air-dryer for blow-drying the print on the substrate. In such a case, the drying unit can have an air circulation device, say a fan, for creating air flow, a heating element for heating the air, and one or more air channels for directing the hot air towards the substrate with the wet print thereon. In another example, the drying unit can simply be formed by one or more heating elements. In such a case, the substrate with the wet print can be passed in vicinity of the heating elements for facilitating the drying of the wet print. In operation, the substrate guiding unit can provide for continuous running of the substrate web under the print-head. According to an aspect, the ink dispensing unit 300 applies the ink composition on the substrate web and, while the ink is dried, the varnish dispensing unit 400 dispenses the varnish composition on the printed substrate, over the ink. In some examples, the over-print varnish composition is applied on the printed media once the ink composition has been applied and dried, eventually by the use of a drier.

During operation of the inkjet printing system, the ink dispensing unit applies the ink composition on the printable medium and. In some examples, the ink is dried before the application of the over-print varnish composition. The over-print varnish composition can be applied offline of the printing process or can be applied in line during web printing process.

Method for Printing

The present invention disclosure relates to a method of printing in an inkjet printing system. In some examples, the method for printing in an inkjet printing system comprises applying an ink composition, on a printable medium, comprising at least one ink chambers containing an ink composition with a pigment dispersion, a surfactant, a polyurethane binder, a co-solvent and a balance of water; drying the ink composition; and applying an over-print varnish composition, on the printable medium, over the ink composition, said over-print varnish composition comprising a latex polymer, a boron-containing compound and water; and drying the over-print varnish composition. In some examples, the method for printing in an inkjet printing system comprises the application of a pre-treatment fixing fluid composition on the printable medium, before applying the ink composition.

In some examples, the ink composition disclosed herein, are established on at least a portion of a print media or substrate to form an image (i.e., text, graphics, etc.) using a printing technique. The amount of ink used depends, at least in part, on the desirable image to be formed. The ink composition may be deposited, established, or printed on the printable medium using any suitable printing device. In some examples, the ink composition is applied to the printable medium via inkjet printing techniques. The ink may be deposited, established, or printed on the medium via continuous inkjet printing or via drop-on-demand inkjet printing, which includes thermal inkjet printing and piezoelectric inkjet printing. The resulting printed image will have, for examples, enhanced image quality and image permanence. The printable medium or media that will be printed may be any type of printable media. The printable medium can be specifically designed to receive any inkjet printable ink.

The printing of the over-print varnish composition may be accomplished using a high-speed printing apparatus at print speeds of at least 50 fpm, and up to 1000 fpm. Examples of suitable high speed printing apparatuses include thermal inkjet printers or web presses, piezoelectric inkjet printers or web presses, or continuous inkjet printers or web presses. The over-print varnish composition may be printed directly onto the surface printed surface of the printable medium, i.e. over the ink composition.

In one example of the printing method, a drying operation is performed after the ink is applied on the medium. The ink composition is applied and dried before any application of the over-print varnish composition on the medium with the ink composition thereon. When multiple ink colors are used, it is to be understood that all of the inks are applied while previously deposited layers are still wet.

In some examples, the printable medium is a packaging recording substrate, a label or a label stock. Packaging, recording media or labels are indeed particularly well suited with the use of this ink set ink. As “packaging recording substrate”, it is meant herein non-absorptive plastics and films thereof employed for so-called soft packaging, in addition to non-coated paper and coated paper. The packaging recording substrate can be packaging glassware (beverage bottles, cosmetic containers) or commercial glassware. A “label” is defined herein as a piece of paper, polymer, cloth, metal, or other material affixed to a container or article. As “label stock”, it is meant herein a media substrate that can be coated on one side with adhesive and that can be printed on the other side. Label stocks can be a wide variety of papers, films, fabric, foils, etc. In sonic other examples, the recording media is a dark packaging recording media or dark label stock media.

### EXAMPLES

Ingredients:

TABLE 1

| Ingredient name | Nature of the ingredient | supplier |
|---|---|---|
| Polyurethane polymer | Grafted polyurethane | HP Inc. |
| | polymer | |
| Surfynol ® 440 | Surfactants | Air Products |
| Dynol ® 360 | Surfactants | Air Products |
| Crodafos ® N3 | Phosphate Ester | Croda |
| LEG-1 | Glyerol ethoxylate | Lipo |
| | | Chemicals |
| | | Inc. |
| Dowanol ® TPM | Tripropylene Glycol | Dow |
| | Methyl Ether | chemical |
| Glycerol | 1,2,3-propanetriol, | Sigma- |
| | glycerin | Aldrich |
| Liquilube ® LL 405 | wax | Lubrizol |
| Black Dispersion | Pigment with styrene | HP Inc. |
| | acrylic dispersant | |
| Cyan Dispersion | Pigment with styrene | HP Inc. |
| | acrylic dispersant | |
| Magenta Dispersion | Pigment with styrene | HP Inc. |
| | acrylic dispersant | |
| Yellow Dispersion | Pigment with styrene | HP Inc. |
| | acrylic dispersant | |
| Orange Dispersion | Pigment with styrene | HP Inc. |
| | acrylic dispersant | |
| Green Dispersion | Pigment with styrene | HP Inc. |
| | acrylic dispersant | |
| Violet Dispersion | Pigment with styrene | HP Inc. |
| | acrylic dispersant | |
| Acticide ® B20 | biocide | Thor |
| Acticide ® M20 | biocide | Thor |

### Example 1

### Ink Set Ink and Ink Composition

Different inkjet ink compositions are prepared with the components and the amounts as listed in Table 2. All percentages are expressed in wt % of the total weight of the ink composition. The pH is adjusted by addition of KOH in order to achieve a pH of about 8.5. Table 2, below, shows constituents of seven different ink compositions. Ink 1 is a black ink comprising a back pigment; Ink 2 is a cyan ink comprising a cyan pigment; Ink 3 is a magenta ink comprising a magenta pigment; Ink 4 is a yellow ink comprising a yellow pigment; Ink 5 is an orange ink comprising an orange pigment; Ink 6 is a green ink comprising a green pigment; Ink 7 is a violet ink comprising a violet pigment.

TABLE 2

| Components | Ink 1 | Ink 2 | Ink 3 | Ink 4 | Ink 5 | Ink 6 | Ink 7 |
|---|---|---|---|---|---|---|---|
| Polyurethane | 5.00% | 3.50% | 3.50% | 3.50% | 3.50% | 3.50% | 3.50% |
| Polymer | | | | | | | |
| Surfynol ® 440 | 0.15% | 0.15% | 0.15% | 0.15% | 0.15% | 0.15% | 0.15% |
| Dynol ® 360 | 0.15% | 0.15% | 0.15% | 0.15% | 0.15% | 0.15% | 0.15% |
| Crodafos ® N3 | 0.50% | 0.50% | 0.50% | 0.50% | 0.50% | 0.50% | 0.50% |
| LEG-1 | 2.00% | 1.00% | 2.00% | 2.00% | 2.00% | 2.00% | 2.00% |
| Dowanol ® TPM | 2.00% | 2.00% | 2.00% | 3.00% | 3.00% | 3.00% | 3.00% |
| Glycerol | 7.00% | 6.00% | 7.00% | 7.00% | 7.00% | 7.00% | 7.00% |
| Liquilube ® LL 405 | 0.75% | 0.50% | 0.50% | 0.50% | 0.50% | 0.50% | 0.50% |
| Black Dispersion | 2.75% | | | | | | |
| Cyan Dispersion | | 2.75% | | | | | |
| Magenta Dispersion | | | 4.00% | | | | |
| Yellow Dispersion | | | | 4.00% | | | |
| Orange Dispersion | | | | | 4.25% | | |
| Green Dispersion | | | | | | 3.40% | |
| Violet Dispersion | | | | | | | 1.5% |
| Acticide ® B20 | 0.15% | 0.15% | 0.15% | 0.15% | 0.15% | 0.15% | 0.15% |
| Acticide ® M20 | 0.07% | 0.07% | 0.07% | 0.07% | 0.07% | 0.07% | 0.07% |
| Water | balance | balance | balance | balance | balance | balance | balance |

The over-print varnish composition A is prepared in accordance with table 3 below. All percentages are expressed in wt % of the total weight of the ink composition. All inkjet ink compositions 1 to 7 and the over-print varnish composition A are then loaded into an ink set.

TABLE 3

| Components | OPV composition A |
|---|---|
| Boron Sodium Oxide | 4.00% |
| Styrene Acrylate resin | 28.00% |
| Water | Balance |

### Example 2

### Print Performances

In the present case, porous uncoated papers are used for comparing the print performances of the above combinations of ink and fixer compositions. The equipment used for printing includes a prototype printer with a media conveyer and ink nozzle positions selected to simulate high speed printing. The media conveyor is set at a speed of about 100 fpm. In addition, infrared (IR) drying and convection drying techniques are used for drying the print. The printable media are printed with the inks 1 to 7 as described above and with or without the over-print varnish composition A. The printed samples are then tested for their print quality (OD and gloss) and for their durability (200 cyc Sutherland Rub and Heated Sutherland).

The Gloss test measures how much light is reflected with 75-degree geometry on a printed media. 75° Gloss testing is carried out by Gloss measurement of the unprinted area of the sheet. The OD measures the optical density of black areas fill. OD and Gloss are measured with an X-Rite spectrophotometer®. The Durability test, in accordance with ASTM D-5264, is performed by exposing the various Samples to be tested with a Sutherland® Ink Rub tester with 4 lb weigh and 200 cycles, Heated Sutherland Rub is 3 cycles with an iron heated to 350° C. It is designed to evaluate the scuffing or rubbing resistance of the printed or coated surface of paper, paperboard, film and other materials. The Sutherland® Ink Rub tester features a digital counter with a fiber optic sensor for accuracy and is compatible with the requirements of the ASTM D-5264 test method. on normal and heated condition). The “visual difference” in the printed surface are visually rated (with a score between 1 and 5; 1 is worst, 5 is best).

The results of these tests are illustrated in Table 4. The results obtained demonstrate that the use of the over-print varnish composition A in combination with any of the ink compositions 1 to 7 significantly improve durability performances, gloss and optical density of the printed samples.

TABLE 4

| | KOD | | 75° Gloss | | Sutherland Rub | | Heated Sutherland | |
|---|---|---|---|---|---|---|---|---|
| | No | With | No | With | No | With | No | With |
| | OPV | OPV | OPV | OPV | OPV | OPV | OPV | OPV |
| Ink 1 | 1.78 | 2.23 | 75.7 | 87.70 | 3.0 | 5.0 | 3.0 | 5.0 |
| Ink 2 | 1.42 | 1.55 | 67.9 | 84.70 | 4.0 | 5.0 | 3.0 | 5.0 |
| Ink 3 | 1.44 | 1.53 | 73.1 | 86.60 | 4.0 | 5.0 | 3.0 | 5.0 |
| Ink 4 | 1.46 | 1.53 | 73.8 | 85.60 | 5.0 | 5.0 | 4.0 | 5.0 |

1. An inkjet ink set comprising:
a. a liquid ink including a pigment dispersion, a surfactant, a polyurethane binder, a co-solvent and a balance of water; and
b. an over-print varnish composition comprising a latex polymer, a boron- containing compound and water.

2. The inkjet ink set as defined in claim 1 wherein, in the over-print varnish composition, the boron-containing compound is selected from the group consisting of boric acid, borax, sodium tetraborate, phenyl boronic acid, butyl boronic acid, and combinations thereof.

3. The inkjet ink set as defined in claim 1 wherein, in the over-print varnish composition, the boron-containing compound is sodium tetraborate.

4. The inkjet ink set as defined in claim 1 wherein, in the over-print varnish composition, the latex polymer comprises an acrylic polymer.

5. The inkjet ink set as defined in claim 1 wherein, in the over-print varnish composition, the latex polymer is a styrene-acrylic polymer.

6. The inkjet ink set as defined in claim 1 comprising several liquid inks, such inks being one or several inks selected from the group consisting of a black ink with a black pigment dispersion; a yellow ink with a yellow pigment dispersion; a cyan ink with a cyan pigment dispersion; a magenta ink with a magenta pigment dispersion; an orange ink with an orange pigment dispersion; a violet ink with a violet pigment dispersion and a green ink with a green pigment dispersion and wherein at least one of these inks includes a surfactant, a polyurethane binder, a co-solvent and a balance of water.

7. The inkjet ink set as defined in claim I wherein, in the liquid ink, the polyurethane binder is a polyurethane graph polyol dispersion.

8. The inkjet ink set as defined in claim 1 wherein, in the liquid ink, the polyurethane binder contains a polyisocyanate; a first polyol having a chain with two hydroxyl functional groups at one end of the chain and no hydroxyl groups at an opposed end of the chain and a second polyol having a chain with two hydroxyl functional groups at both ends of the chain.

9. The inkjet ink set of claim 1 wherein, in the liquid ink, the surfactant is a non-ionic surfactant including an acetylenic surfactant and/or a phosphate surfactant.

10. The inkjet ink set as defined in claim 1 wherein the liquid ink further comprises a polyethylene wax emulsion.

11. The inkjet ink set as defined in claim 1 that further comprises a pre-treatment fixing fluid including calcium-containing crashing agents and a balance of water.

12. The inkjet ink set as defined in claim 11 wherein, in the pre-treatment fixing fluid, the calcium-containing crashing agents consist of a mixture of calcium propionate and calcium nitrate wherein the calcium propionate is present in an amount ranging from 0 wt % to about 10 wt % and wherein the calcium nitrate is present in an amount ranging from about 15 wt % to 0 wt % based on the total wt % of the pre-treatment fixing fluid.

13. An inkjet printing system comprising:
a. an ink dispensing unit, for applying an ink composition on the substrate, comprising at least one ink chambers containing an ink composition comprising a pigment dispersion, a surfactant, a polyurethane binder, a co-solvent and a balance of water; and
b. a varnish dispensing unit, for applying an over-print varnish composition over the ink composition, said over-print varnish composition comprising a latex polymer, a boron-containing compound and water.

14. The inkjet printing system as defined in claim 13 wherein the ink dispensing unit comprises several ink chambers with inks of different colors, said inks being one or more inks selected from the group consisting of a black ink with a black pigment dispersion; a yellow ink with a yellow pigment dispersion; a cyan ink with a cyan pigment dispersion; a magenta ink with a magenta pigment dispersion; an orange ink with an orange pigment dispersion; a violet ink with a violet pigment dispersion and a green ink with a green pigment dispersion.

15. A method for printing in an inkjet printing system, the method comprising:
a. applying an ink composition, on a printable medium, comprising at least one ink chamber containing an ink composition comprising a pigment dispersion, a surfactant, a polyurethane binder, a co-solvent and a balance of water;
b. drying the ink composition;
c. and applying an over-print varnish composition, on the printable medium, over the ink composition, said over-print varnish composition comprising a latex polymer, a boron-containing compound and water.
